(19) United States
(12) Patent Application Publication
(10) Pub. No.: US 2010/0015300 A1
(43) Pub. Date: Jan. 21, 2010

(54) RETORTABLE RADIATION-CURED COATINGS FOR PLASTIC FILM AND METALLIC FOIL SUBSTRATES

(76) Inventor: Alexander P. Mgaya, Cary, NC (US)

Correspondence Address: Henkel Corporation, 10 Finderne Avenue, Bridgewater, NJ, 08807, US

(21) Appl. No.: 12/301,135

(22) PCT Filed: May 15, 2007
(86) PCT No.: PCT/US07/68919

§ 371 Date: Aug. 19, 2009

Related U.S. Application Data
(60) Provisional application No. 60/811,229, filed on Jun. 5, 2006.

(51) Int. Cl. B65D 85/00; B32B 27/08; B65B 55/00

(52) U.S. Cl. 426/127; 428/35.7; 426/412

(57) ABSTRACT

A printed image on the outside surface of a food package fabricated using a thin, flexible substrate may be protected against degradation during retorting of the food package by radiation curing a layer of a liquid composition placed on the outside surface. The liquid composition contains at least one radiation-curable monomer or oligomer containing one or more (meth)acrylate groups per molecule and one or more functional groups per molecule selected from the group consisting of hydroxyl groups and carboxylic acid groups, such as an epoxy (meth)acrylate and/or carboxylic acid-functionalized (meth)acrylate.

### FIELD OF THE INVENTION

This invention relates to liquid, relatively low viscosity compositions that can be applied to the surface of a thin, flexible substrate and then cured by irradiation to provide coatings that exhibit excellent resistance to retort conditions. Such compositions are particularly useful for forming top coatings for flexible laminates and the like that are intended for use in packaging foods.

### DISCUSSION OF THE RELATED ART

Printed thermoplastic films, which typically are laminates having layers comprised of different materials, are currently in wide use for food packaging. Due to the extreme conditions (particularly heat and moisture) that the printed thermoplastic films are subjected to during fabrication, filling, sealing and other processing of such food packages, it is known to laminate a clear film over the substrate layer bearing the printed image to protect the printed image from being distorted or degraded during such processing. While effective, this method of sealing the printed image adds cost to the manufacturing process.

In recent years, radiation-curable overprint varnishes have been developed for the purpose of replacing the above-described clear film lamination step. These overprint varnishes are applied in liquid form as a thin layer over the printed substrate surface and then cured (hardened) by exposing the layer to radiation (e.g., ultraviolet light or electron beam radiation). Such overprint varnishes and methods of utilizing them to prepare food packaging are described, for example, in U.S. Pat. Nos. 6,528,127 and 6,743,492 and U.S. Application Nos. 2005-0019533 and 2002-0119295, each incorporated herein by reference in its entirety. The aforementioned applications and patents do not, however, provide any guidance with respect to formulating a composition that, when cured by irradiation, will provide a moisture- and heat-resistant protective coating capable of withstanding retort conditions (i.e., 121 degrees C., 15 psi pressure, 30 minutes) with minimum reduction of gloss and adhesive strength and that exhibits little or no delamination, water spot development, or odor following retorting of a food contained within a package having such a cured coating on its exterior surface.

The development of improved radiation-curable, low viscosity, liquid compositions for use in the manufacture of printed image-bearing food packages that are subjected to retort conditions thus would be highly desirable.

### BRIEF SUMMARY OF THE INVENTION

In one aspect, the present invention provides a retortable package comprised of at least one thin, flexible substrate selected from the group consisting of plastic films and metallic foils, wherein said thin, flexible substrate forms an outer surface of said retortable package and wherein said outer surface has a cured coating thereupon formed by exposing a composition comprising at least one radiation-curable monomer or oligomer containing one or more (meth)acrylate groups per molecule and one or more functional groups per molecule selected from the group consisting of hydroxyl groups and carboxylic acid groups to at least one of electron beam radiation or ultraviolet radiation.

In another aspect, the present invention provides a packaged food product comprising:
a). a food product; and
b). a package enclosing the food product, the package comprising a coated, printed sheet which is thin and flexible and which comprises:
   i). a substrate film comprising one or more thermoplastic polymers, the substrate film having a print side on the outside of said package (where the print side may be plastic or metallic);
   ii). an image printed on the print side of the substrate film; and
   iii). a cured coating over the image which is formed by applying a layer of a composition comprising at least one radiation-curable monomer or oligomer containing one or more (meth)acrylate groups per molecule and one or more functional groups per molecule selected from the group consisting of hydroxyl groups and carboxylic acid groups and exposing said composition to at least one of electron beam radiation and ultraviolet radiation.

In still another aspect, the present invention provides a method of preparing a packaged food product, said method comprising:
a). placing a food product in a package;
b). sealing said package so as to enclose said food product in said package to produce a sealed package; and
c). subjecting said sealed package enclosing said food to retort conditions; wherein said package comprises a coated, printed sheet which is thin and flexible and which is comprised of:
   i). a substrate film comprising one or more thermoplastic polymers, the substrate film having a metallic or plastic print side on the outside of said package;
   ii). an image printed on the print side of the substrate film; and
   iii). a cured coating over the image which is formed by applying a layer of a composition comprising at least one radiation-curable monomer or oligomer containing one or more (meth)acrylate groups per molecule and one or more functional groups per molecule selected from the group consisting of hydroxyl groups and carboxylic acid groups and exposing said composition to at least one of electron beam radiation and ultraviolet radiation.

The present invention in still another aspect provides compositions capable of being applied to a substrate as a liquid layer and then cured by exposure to ultraviolet and/or electron beam radiation to provide a cured coating which protects the substrate surface (including, for example, an image which may be printed upon the surface) during exposure to retort conditions. For example, the cured coating thereby obtained is capable of exhibiting low odor, excellent gloss retention, low shrinkage and strong adhesion to the substrate surface, even after the coated substrate is fabricated into a package containing food and then retorted. The radiation-curable compositions of the present invention may also be selected so as to provide fast cure rates.

### DETAILED DESCRIPTION OF CERTAIN EMBODIMENTS OF THE INVENTION

The present invention utilizes compositions that are capable of being cured by exposure to ultraviolet (UV) and/or electron beam (EB) radiation and that comprise at least one radiation-curable monomer or oligomer containing one or more (meth)acrylate groups per molecule and one or more functional groups per molecule selected from the group consisting of hydroxyl groups and carboxylic acid groups (such monomers and oligomers may sometimes hereinafter be referred to collectively as “Component A”). Mixtures of such monomers and/or oligomers may be advantageously used, as will be explained subsequently in more detail. The term “(meth)acrylate” refers herein to functional groups that may be either acrylate or methacrylate functional groups.

To permit facile application of the radiation-curable composition to substrates that are to be coated, the components of the composition are selected so as to provide a viscosity at 25 degrees C. of from about 100 to about 300 cps (e.g., about 130 to about 250 cps).

Epoxy (meth)acrylates, particularly aliphatic epoxy (meth)acrylates, are one especially preferred class of compounds suitable for use as a portion or all of Component A. Epoxy (meth)acrylates are the beta-hydroxy esters which are generated by the reaction of acrylic acid and/or methacrylic acid (or an equivalent thereof, such as an anhydride) with an epoxy compound, preferably an epoxy compound having an epoxy functionality of two or greater. Especially preferred are the relatively low viscosity epoxy (meth)acrylates derived from diglycidyl ethers obtained by reaction of epichlorohydrin with an aliphatic alcohol containing two or more hydroxyl groups per molecule. Suitable aliphatic alcohols include, for example, glycols such as ethylene glycol, 1,2-propanediol, 1,3-propanediol, 1,2-butanediol, 1,4-butanediol, 1,6-hexanediol, neopentyl glycol and other linear and branched C2-C10 aliphatic diols, triols such as glycerin, trimethyolpropane, trimethylolethane, butanetriols, pentanetriols, and the like, tetrols such as pentaerythritol, as well as other polyfunctional alcohols such as dipentaerythritol, sugar alcohols and the like and alkoxylated derivatives thereof (where the alcohol has been reacted with an alkylene oxide such as ethylene oxide or propylene oxide, including both oligomeric species such as diethylene glycol or tripropylene glycol as well as polymeric species such as polyethylene glycols or polypropylene glycols or block, capped or random copolymers of ethylene oxide and propylene oxide). The alcohol may also be an aromatic alcohol such as bisphenol A, bisphenol F, or the like. The epoxy compound reacted with the (meth)acrylic acid may also be an epoxidized unsaturated triglyceride such as epoxidized soybean oil or epoxidized linseed oil. Preferably, all or essentially all of the epoxy groups on the epoxy compound are ring-opened with the (meth)acrylic acid. Suitable preferred epoxy (meth)acrylates thus have two, three, or more (meth)acrylate groups and two, three, or more hydroxyl groups per molecule. Specific illustrative examples of suitable epoxy compounds include hexanediol diglycidyl ethers, neopentyl glycol diglycidyl ethers, and butanediol diglycidyl ethers.

Carboxylic acid-functionalized mono(meth)acrylates represent another class of compounds preferred for use as a portion or all of Component A. Especially suitable monomers of this type include carboxylic acid-functionalized ester-containing (meth)acrylate monomers, e.g., compounds containing at least one carboxylic acid group (—CO₂H), at least one acrylate and/or methacrylate group, and at least one ester linkage (in addition to the acrylate and/or methacrylate group(s)) per molecule. Such substances are well-known in the art and may be prepared using any suitable synthetic method. For example, one such method involves reacting a compound containing both at least one hydroxyl group and at least one (meth)acrylate group with an anhydride. The resulting product may be considered a “half-ester”. Suitable anhydrides include, but are not limited to anhydrides of aromatic and aliphatic polycarboxylic acids such as: phthalic anhydride; isophthalic anhydride; terephthalic anhydride; trimellitic anhydride; tetrahydrophthalic anhydride; hexahydrophthalic anhydride; tetrachlorophthalic anhydride; adipic anhydride; azelaic anhydride; sebacic anhydride; succinic anhydride; glutaric anhydride; malonic anhydride; pimelic anhydride; suberic anhydride; 2,2-dimethylsuccinic anhydride; 3,3-dimethylglutaric anhydride; 2,2-dimethylglutaric anhydride; dodecenylsuccinic anhydride; nadic methyl anhydride; HET anhydride; and the like. Alkyl-, alkenyl- and alkynyl-substituted cyclic anhydrides such as substituted succinic anhydrides, substituted glutaric anhydride, and the like may also be utilized. The alkyl, alkenyl or alkenyl substituent may, for example, contain from 1 to 18 carbon atoms and may be straight chain, cyclic or branched. The compound containing at least one hydroxyl group and at least one (meth)acrylate group may, for example, be selected from the following: 2-hydroxyethyl (meth)acrylate; 2-hydroxypropyl (meth)acrylate; 2-hydroxybutyl (meth)acrylate; 2-hydroxy 3-phenyloxypropyl (meth)acrylate; 1,4-butanediol mono(meth)acrylate; 4-hydroxycyclohexyl (meth)acrylate; 1,6-hexanediol mono(meth)acrylate; neopentylglycol mono(meth)acrylate; trimethylolpropane di(meth)acrylate; trimethylolethane di(meth)acrylate; pentaerythritol tri(meth)acrylate; dipentaerythritol penta(meth)acrylate; and other hydroxy functional (meth)acrylates such as the hydroxy terminated (meth)acrylate monomers based on caprolactone sold under the brand name TONE by Dow Chemical (e.g. TONE M-100, M-101, and M-201).

Carboxylic acid-functionalized ester-containing (meth)acrylate monomers suitable for use in the present invention are available from commercial sources, including, for example, ECX 4046 from Cognis Corporation and the series of specialty oligomers sold by the Sartomer Company under the brand name SARBOX. Other suitable carboxylic acid functionalized materials suitable for use as Component A of the present invention include PHOTOMER 4703 and PHOTOMER 4846 from Cognis Corporation.

Also useful as carboxylic acid-functionalized ester-containing (meth)acrylate monomers are the adhesion promoters described in U.S. Pat. No. 6,429,235, incorporated herein by reference in its entirety. These compounds have the general formula:

CH₂═C(R¹)CO₂—R²—O—C(O)—CR³R⁴—CR⁵R⁶—(—CR⁷R⁸)—CO₂H

wherein R¹ is hydrogen or methyl, R² is a substituted or unsubstituted alkylene groups having from 2 to about 6 carbon atoms, and R³, R⁴, R⁵, R⁶, R⁷, and R⁸ are independently selected from the group consisting of hydrogen and straight or branched chain, saturated or unsaturated aliphatic, cycloaliphatic or polycycloaliphatic groups possessing from 1 to about 20 carbon atoms, subject to the provision that at least one of groups R³, R⁴, R⁵, R⁶, R⁷, and R⁸ is other than hydrogen, and n is 0 or 1. In one embodiment, at least one of R³, R⁴, R⁵, R⁶, R⁷, or R⁸ is an unsaturated aliphatic group. Octenyl and dodecenyl are particular examples of suitable substituents.

Illustrative specific examples include the octenyl-mono{1-methyl-2-[(2-methyl-1-oxo-2-propenyl)oxy]-1-methyl-ethyl}ester of butanedioic acid; the dodecenyl mono{1-methyl-2-[(2-methyl-1-oxo-2-propenyl)oxy]-1-methyl-ethyl}ester of butanedioic acid; the octenyl-mono{2-[(2-methyl-1-oxo-2-propenyl)oxy]ethyl}ester of butanedioic acid; and the dodecenyl mono{2-[(2-methyl-1-oxo-2-propenyl)oxy]ethyl}ester of butanedioic acid.

The above-mentioned compounds can be synthesized as described in U.S. Pat. No. 6,429,235 by reacting a hydroxy alkyl ester of (meth)acrylic acid with, for example, an alkyl-, alkenyl-, or alkynyl-substituted cyclic anhydride such as a substituted succinic anhydride, substituted glutaric anhydride, or the like. Suitable hydroxyalkyl esters of (meth) acrylic acid may correspond to the formula:

CH₂═C(R¹)—CO₂—R²—OH

wherein R¹ is hydrogen or methyl, and R² is a substituted or unsubstituted alkylene group having from 2 to about 6 carbon atoms. Suitable unsubstituted alkylene groups include, for example, —CH₂CH₂— and —CH₂CH₂CH₂—. A suitable methyl-substituted alkylene group can include, for example, —CH₂C(CH₃)H—. Suitable hydroxyalkyl (meth)acrylate esters include, for example, hydroxy ethyl acrylate, hydroxyethyl methacrylate,hydroxypropyl acrylate, and hydroxypropyl methacrylate.

U.S. Pat. Nos. 3,770,491; 6,472,056; 6,720,050; 6,908,665; and 6,989,407 (each of which is incorporated herein by reference in its entirety) also describe carboxylic acid-functionalized compounds suitable for use as Component A in the radiation-curable compositions employed in the present invention.

In preferred embodiments of the invention, the radiation-curable composition contains from about 35 to about 65 weight percent of Component A in total, which as explained before can be a single type of hydroxy- and/or carboxylic-functionalized compound or a mixture of different compounds.

In one embodiment of the invention, the radiation-curable composition contains, in addition to Component A, at least one (meth)acrylate-functionalized monomer or oligomer that does not contain either hydroxyl or carboxylic acid functional groups.

Especially preferred monomers or oligomers of this type include, but are not limited to, alkoxylated alcohol (meth)acrylates in which the hydroxyl groups of an alkoxylated alcohol have been esterified to provide at least one (meth)acrylate functional group per molecule. “Alkoxylated alcohol” in the context of this invention is intended to mean an alcohol containing one or more hydroxyl groups that has been reacted with one or more molecules of an alkylene oxide such as ethylene oxide and/or propylene oxide or a compound having a similar structure prepared by other synthetic means. The alkoxylated alcohol thus has at least one ether linkage per molecule. The (meth)acrylate functional groups are typically introduced by esterifying the hydroxyl groups of the alkoxylated alcohol with acrylic acid, methacrylic acid, or an equivalent thereof, although other synthetic means to prepare the alkoxylated alcohol containing at least one (meth)acrylate functional group per molecule may of course be employed. The alcohol is preferably aliphatic in character and may contain one, two, three or more hydroxyl groups per molecule. Suitable alcohols include, for example, methanol, ethanol, n-propanol, iso-propanol, cyclohexanol and other C1-C8 aliphatic alcohols (including linear, branched and alicyclic alcohols), glycols such as ethylene glycol, 1,2-propanediol, 1,3-propanediol, 1,2-butanediol, 1,4-butanediol, 1,6-hexanediol, neopentyl glycol and other linear and branched C2—C10 aliphatic diols, triols such as glycerin, trimethyolpropane, trimethylolethane, butanetriols, pentanetriols, and the like, tetrols such as pentaerythritol, as well as other alcohols such as dipentaerythritol, sugar alcohols and the like. Aromatic alcohols such as phenol, bisphenol A, benzyl alcohol, and the like may also be employed. From 1 to 20 alkylene oxide units (derived, for example, from ring-opening reaction of an alkylene oxide with the alcohol) may be present in each molecule of the alkoxylated alcohol. Mixtures of alkoxylated alcohols containing varying amounts of alkylene oxide units per molecule may be utilized. Illustrative examples of suitable alkoxylated alcohols containing at least one (meth)acrylate functional group per molecule include, but are not limited to, (2-ethoxyethoxy)ethyl (meth)acrylate, ethoxylated nonyl phenol (meth)acrylates, (meth)acrylate-functionalized alkoxylated alcohols such as those described in U.S. Pat. Nos. 4,876,384; 5,053,554; 5,110,889; 5,159,119; 5,243,085; and 5,292,965 (each of which is incorporated herein by reference in its entirety), monomethoxy tripropylene glycol mono(meth)acrylates, neopentylglycol propoxylate methylether mono(meth)acrylates, alkoxylated cyclohexane dimethanol di(meth)acrylates, triethylene glycol di(meth)acrylates, tetraethylene glycol di(meth)acrylates, dipropylene glycol di(meth)acrylates, tripropylene glycol di(meth)acrylates, ethoxylated trimethylolpropane tri(meth)acrylates, alkoxylated 1,6-hexanediol di(meth)acrylates and the like.

In one embodiment, the radiation-curable composition contains at least one mono(meth)acrylate-functionalized alkoxylated alcohol and at least one di(meth)acrylate-functionalized alkoxylated alcohol. In one embodiment, the radiation-curable composition contains at least one mono(meth)acrylate-functionalized alkoxylated alcohol and at least one tri(meth)acrylate-functionalized alkoxylated alcohol.

In one embodiment, the radiation-curable composition contains at least one di(meth)acrylate-functionalized alkoxylated alcohol and at least one tri(meth)acrylate-functionalized alkoxylated alcohol. In one embodiment, the radiation-curable composition contains at least one mono(meth)acrylate-functionalized alkoxylated alcohol, at least one di(meth)acrylate-functionalized alkoxylated alcohol, and at least one tri(meth)acrylate-functionalized alkoxylated alcohol.

Preferred radiation-curable compositions contain at least one alkoxylated cycloaliphatic dialcohol di(meth)acrylate such as an alkoxylated cyclohexane dimethanol di(meth)acrylate, preferably at a concentration of from about 2 to about 15 or about 5 to about 12 weight percent. Suitable materials of this type are sold by the Sartomer Company under the product designations CD580, CD581 and CD582. In another preferred embodiment, at least one 1,6-hexanediol alkoxylate di(meth)acrylate is present, preferably in a concentration of from about 15 to about 30 or about 18 to about 26 weight percent. Suitable 1,6-hexanediol alkoxylate di(meth)acrylates are available from Cognis Corporation under the product names PHOTOMER 4361 and PHOTOMER 4362. In yet another preferred embodiment, the radiation-curable composition is comprised of at least one monoalkoxy neopentyl glycol alkoxylate mono(meth)acrylate such as monomethoxy neopentyl glycol propoxylate monoacrylate, with the concentration of this component preferably being from about 2 to about 12 or about 4 to about 10 weight percent. Still another embodiment of the present invention provides a radiation-curable composition containing at least one alkoxylated trimethylolpropane tri(meth)acrylate such as an ethoxylated trimethylolpropane triacrylate, preferably at a concentration of from about 7 to about 18 or about 9 to about 16 weight percent. Suitable alkoxylated trimethylolpropane tri(meth)acrylates are available from Cognis Corporation under the product names PHOTOMER 4149, PHOTOMER 4149F, PHOTOMER 4072, PHOTOMER 4072F, PHOTOMER 4155 and PHOTOMER 4158.

The radiation-curable composition utilized in the present invention may contain, in one preferred embodiment, a total of from about 40 to about 60 weight percent alkoxylated alcohols containing at least one (meth)acrylate functional group per molecule. In particular embodiments, the composition may contain about 3 to about 10 weight percent of one or more alkoxylated alcohol mono(meth)acrylates, about 25 to about 35 weight percent of one or more alkoxylated alcohol di(meth)acrylates, and/or about 6 to about 20 weight percent of one or more alkoxylated alcohol tri(meth)acrylates.

Preferably, the radiation-curable composition contains less than 20 weight percent or, more preferably, less than 10 weight percent of monofunctional components (i.e., monomers, oligomers and/or polymers containing just one acrylate or methacrylate group per molecule).

When the composition is intended to be cured by exposure to ultraviolet light, the composition preferably contains at least one photoinitiator which initiates the polymerization of olefinically unsaturated double bonds under UV irradiation.

Accordingly, one or more photoinitiators capable of initiating the radical polymerization of olefinically unsaturated double bonds on exposure to light with a wavelength of about 215 to about 480 nm may be used. In principle, any commercially available photoinitiators which are compatible with the radiation-curable composition according to the invention, i.e., which form at least substantially homogeneous mixtures, may be used as photoinitiators for the purposes of the present invention. It is also desirable to select a photoinitiator that is low in volatility, does not discolor the cured composition following irradiation, and does not produce by-products capable of migrating through the substrate to which the radiation-curable composition is applied.

Suitable photoinitiators include, for example, phosphine oxide photoinitiators, benzoin alkyl ether photoinitiators, dialkoxyacetophenone initiators, aldehyde and ketone photoinitiators having at least one aromatic nucleus attached directly to the carbon atom of the carbonyl group, and alpha-hydroxyketone photoinitiators. The radiation-curable composition according to the invention may contain one or more photoinitiators in a quantity of 0 to 15% by weight, based on the composition as a whole.

Other types of radiation-curable monomers, oligomers and polymers other than the aforementioned materials may also be present in the composition such as, for example, (meth)acrylate oligomers (including, for example, urethane (meth)acrylate oligomers, (meth)acrylic polyol (meth)acrylates, polyester (meth)acrylate oligomers, polyamide (meth)acrylate oligomers, polyether (meth)acrylate oligomers, polybutadiene (meth)acrylate oligomers, reactive diluents (including, for example, alkyl (meth)acrylates) and (meth)acrylates of non-alkoxylated polyfunctional alcohols) and the like. However, in preferred embodiments the radiation-curable composition contains less than 20 weight % total (preferably, less than 10 weight % total) of radiation-curable substances other than the radiation-curable monomers and/or oligomers containing one or more (meth)acrylate groups per molecule and one or more functional groups per molecule selected from the group consisting of hydroxyl groups and carboxylic acid groups and the optional (meth)acrylate-functionalized alkoxylated alcohols.

Optionally, the radiation-curable composition may contain one or more other components in addition to those mentioned above, but preferably such additional components are present in relatively small quantities (e.g., from about 0.01 to about 15 weight % in total). Optional additives include, for example, antiblocking agents, slip agents (e.g., (meth)acrylate-fanctionalized organosilicon compounds and oligomers), adhesion promoters (particularly (meth)acrylate-functionalized phosphorus derivatives), coupling agents, fillers (e.g., inorganic and/or polymeric particles), wetting agents, rheology control agents, defoamers, leveling agents, polymers and prepolymers (e.g., isocyanate-functionalized polyurethane prepolymers, acrylic resins), plasticizers, polymerization inhibitors, processing aids, stabilizers, anti-oxidants and the like. Such additives themselves preferably are reactive so that they are capable of polymerizing and/or crosslinking when the composition is exposed to ultraviolet light or electron beam radiation, thereby becoming covalently incorporated into the cured composition. The additives may, for example, be functionalized with one or more (meth)acrylate groups.

In one embodiment of the invention, the radiation-curable composition contains one or more reactive silicon-containing slip agents capable of reacting with the (meth)acrylate-functionalized components of the composition upon exposure to an effective amount of UV or EB radiation, thereby becoming incorporated into the cured coating. The total amount of such slip agent(s) is typically from about 0.1 to about 10 weight percent. Specific examples of radiation-curable organosilicon slip agents having one or more polymerizable double bonds and which may be monomeric, oligomeric or polymeric in nature include siliconized urethane (meth)acrylates, functional polysilanes having a vinyl group at one or both terminals or elsewhere on the polymer chain, functional polysiloxanes having vinyl groups at one or both terminals or elsewhere on the polymer chain, (meth)acryloxysilane compounds, and the like.

In preferred embodiments of the invention, the radiation-curable composition consists essentially of or consists only of components that will react when exposed to the radiation used to cure the composition. For example, less than 5 weight %, less than 2 weight %, less than 1 weight %, less than 0.5 weight %, or less than 0.1 weight % of non-reactive components are, in certain embodiments, present in the composition. Preferably, the composition is free or essentially free of non-reactive solvents and water.

Preferred embodiments of the radiation-curable composition comprise, in addition to one or more compounds selected from the group consisting of epoxy (meth)acrylates and carboxylic acid-functionalized (meth)acrylate monomers (preferably, in a total amount of from about 40 to about 50 weight percent), at least one alkoxylated alcohol mono(meth)acrylate (preferably, from about 4 to about 10 or about 5 to about 9 weight percent; preferably, a mono-alkoxy neopentyl glycol alkoxylate mono(meth)acrylate such as mono-methoxy neopentyl glycol propoxylate monoacrylate, preferably one containing an average of from about 1 to about 5 moles of reacted propylene oxide per molecule), at least one alkoxylated alcohol di(meth)acrylate (preferably, from about 25 to about 35 or about 28 to about 32 weight percent; preferably, at least one of an alkoxylated cyclohexane dimethanol di(meth)acrylate or an alkoxylated 1,6-hexanediol di(meth)acrylate; more preferably, both an alkoxylated cyclohexane dimethanol di(meth)acrylate and an alkoxylated 1,6-hexanediol di(meth)acrylate), and at least one alkoxylated alcohol tri(meth)acrylate (preferably, from about 8 to about 18 or about 10 to about 15 weight percent; preferably, a trimethylolpropane ethoxylate tri(meth)acrylate, preferably one containing an average of from about 1 to about 6 moles of reacted ethylene oxide per molecule).

Especially preferred embodiments of the radiation-curable composition comprise, consist essentially of, or consist of about 25 to about 50 weight percent epoxy (meth)acrylate, 0 to about 20 weight percent carboxylic acid-functionalized (meth)acrylate monomer (where preferably the total amount of epoxy acrylate and carboxylic acid-functionalized monomer is not greater than about 50 weight percent), about 4 to about 13 weight percent alkoxylated cyclohexane dimethanol di(meth)acrylate, about 17 to about 27 weight percent 1,6-hexanediol alkoxylate di(meth)acrylate, about 9 to about 17 weight percent trimethylolpropane alkoxylate tri(meth)acrylate, about 4 to about 10 weight percent monomethoxy neopentyl glycol alkoxylate mono(meth)acrylate, about 0.5 to about 8 weight percent reactive silicon-containing slip agent, and 0 to 8 weight percent photoinitiator.

A packaged food product in accordance with the present invention comprises a food product enclosed within a package which at least in part is a thin, flexible substrate covered on at least its exterior surface with a cured coating obtained by exposing a composition (sometimes referred to hereinafter as “radiation-curable composition”) comprising at least one radiation-curable monomer or oligomer containing one or more (meth)acrylate groups per molecule and one or more functional groups per molecule selected from the group consisting of hydroxyl groups and carboxylic acid groups to at least one of electron beam radiation or ultraviolet radiation. In a particularly advantageous embodiment, the thin, flexible substrate has an image printed upon it. In another desirable embodiment, the packaged food product is retorted after the package is sealed.

The thin, flexible substrate may be a single layer, but preferably comprises a plurality of layers of different composition that are laminated together such that the layers in combination provide the substrate with the properties desired (e.g., one layer may be a barrier layer, while another layer may be capable of being heat sealed to another material during fabrication of the food package).

The film or films to be coated or adhered to each other using the adhesive formulations of the present invention may be comprised of any of the materials known in the art to be suitable for use in flexible packaging, including both polymeric and metallic materials as well as paper (including treated or coated paper). Thermoplastics are particularly preferred for use as at least one of the layers. The materials chosen for individual layers in a laminate are selected to achieve specific desired combinations of properties, e.g., mechanical strength, tear resistance, elongation, puncture resistance, flexibility/stiffness, gas and water vapor permeability, oil and grease permeability, heat sealability, adhesiveness, optical properties (e.g., clear, translucent, opaque), formability, merchantability and relative cost. Individual layers may be pure polymers or blends of different polymers. The polymeric layers are often formulated with colorants, anti-slip, anti-block, and anti-static processing aids, plasticizers, lubricants, fillers, stabilizers and the like to enhance certain layer characteristics.

Particularly preferred polymers for use in the present invention include, but not limited to, polyethylene (including low density polyethylene (LDPE), medium density polyethylene (MDPE), high density polyethylene (HPDE), high molecular weight, high density polyethylene (HMW-HDPE), linear low density polyethylene (LLDPE), linear medium density polyethylene (LMPE)), polypropylene (PP), oriented polypropylene, clarified polypropylene (CPP), polyesters such as poly (ethylene terephthalate) (PET) and poly (butylene terephthalate) (PBT), ethylene-vinyl acetate copolymers (EVA), ethylene-acrylic acid copolymers (EAA), ethylene-methyl methacrylate copolymers (EMA), ethylene-methacrylic acid salts (ionomers), hydrolyzed ethylene-vinyl acetate copolymers (EVOH), polyamides (nylon), polyvinyl chloride (PVC), poly(vinylidene chloride) copolymers (PVDC), polybutylene, ethylene-propylene copolymers, polycarbonates (PC), polystyrene (PS), styrene copolymers, high impact polystyrene (HIPS), acrylonitrile-butadiene-styrene polymers (ABS), and acrylonitrile copolymers (AN). The polymeric film may be oriented in one or both directions.

The polymer surface may be treated or coated, if so desired. For example, a film of polymer may be metallized by depositing a thin metal vapor such as aluminum onto the film's surface. A layer of inorganic oxide may also be deposited upon the polymeric film. Coating the film with a layer of metal or inorganic oxide may enhance the barrier properties of the finished laminate. The polymer film surface may also be coated with anti-fog additive or the like or subjected to a pretreatment with electrical or corona discharges, or ozone or other chemical agents to increase its adhesive receptivity.

One or more layers of the laminate may also comprise a metal foil, such as aluminum foil, or the like. The metal foil will preferably have thickness of about 5 to 100 μm.

Either a plastic film or a metal foil may comprise the surface of the substrate upon which the radiation-curable composition is applied and then reacted by exposure to an effective amount of radiation to provide a cured coating.

The individual plastic films comprising the thin, flexible substrates can be prepared in widely varying thicknesses, for example, from about 5 to about 200 microns. The total thickness of the thin, flexible substrate is not particularly critical to the present invention, provided that the substrate provides the desired combination of properties (e.g., flexibility, heat resistance, barrier properties, heat shrinkability, heat sealability, tear strength, tensile strength) for the intended end use (e.g., a retortable food package). Typically, the thin, flexible substrate will be from about 0.3 to about 15 mils thick. The films and/or foils may be assembled into the thin, flexible substrate by using any one or more of the several conventional procedures known in the art for such purpose, including adhesive lamination, co-extrusion, extrusion coating, casting, heat sealing and the like.

Although the radiation-curable composition may be applied as a coating to any of the different materials mentioned above that could be used as a layer of the thin, flexible substrate, in especially preferred embodiments the exterior surface of the food package manufactured from the thin, flexible substrate and which is coated with the radiation-curable composition is comprised of either aluminum (e.g., aluminum foil) or a polyester (in particular, polyethylene terephthalate).

As mentioned previously, the radiation-curable compositions of the present invention are particularly useful for protecting a printed image that has been applied to the thin, flexible substrate (normally, on the non-food, outside or exterior side of the substrate). To create the printed image, one or more layers of ink are applied to the substrate using any of the printing techniques conventionally known in the art. One or more inks, including inks of different colors, may be utilized and are selected so as to provide acceptable adhesion, gloss, heat resistance and appearance once printed on the substrate surface. Radiation-curable as well as solvent-based inks or any other types of inks can be employed. The thin, flexible substrate may be treated with the ink(s) to form the desired printed image by means of any suitable method known in the field, such as, but not limited to, rotary screen, gravure or flexographic techniques. The surface of the thin, flexible substrate may be pretreated in some manner so as to improve the adhesion of the ink(s) to the surface, including flame treatment, corona treatment, plasma treatment or primer treatment.

The radiation-curable composition of the present invention is applied as a thin, liquid layer over all or a portion of the thin, flexible substrate (typically, to at least portions of the side of the substrate that will be on the exterior or non-food side of the food package comprising the thin, flexible substrate). If a printed image is present on the substrate surface, it is generally preferred for the entirety of the printed image to be covered by the radiation-curable composition layer. Any of the methods known for creating a thin layer of a liquid on a surface may be used for this purpose, including, for example, roller coating, brushing, spraying, and wiping as well as screen, gravure, flexographic and metering rod coating methods. Application of the radiation-curable composition to the substrate may be integrated with the procedures utilized to manufacture the substrate; for example, the radiation-curable composition may be applied after printing an image on the surface of the thin, flexible substrate. The thickness of the radiation-curable composition layer is selected so as to provide a cured coating (after exposure of the composition to ultraviolet or electron beam radiation) that is effective to impart the desired characteristics to the thin, flexible substrate (for example, gloss, moisture and heat resistance). Typically, the thickness of the cured coating is from about 0.1 to about 20 microns.

The substrate surface having a layer of the radiation-curable composition applied thereto is then exposed to sufficient radiation in the form of ultraviolet light or electron beam radiation to cause reaction of the reactive components of the composition. The reactive components polymerize and/or cross-link so as to harden or cure the composition. Preferably, the amount of radiation is sufficient to induce reaction of at least 90%, more preferably at least 95%, most preferably all or essentially all of the reactive components. In preferred embodiments, the radiation-curable composition and the radiation curing conditions are selected so as to minimize the level of residual substances in the cured coating that can be extracted by solvent (e.g., ethanol) or that migrate through the thin, flexible substrate.

In the present invention, the radiation-curable composition is utilized as a coating and not as an adhesive. That is, the composition is applied in liquid form to a substrate surface and then completely cured (hardened), without another substrate being brought into contact with the composition after being applied to the first surface.

The radiation-curable compositions utilized in the present invention can be cured using conventional techniques for radiation curing, such as irradiation of the composition layer on the substrate surface using UV (ultraviolet) light from low, medium and/or high pressure mercury vapor lamps, He—Cd and Ar lasers, Xenon arc lamps, or other suitable source of radiation. The UV light may have a wavelength of from about 200 to about 450 nanometers. The source of the electron beams (highly accelerated electrons) can be a particle beam processing device. Such devices are well-known in the art and are described, for example, in published U.S. applications 2005-0233121, 2004-0089820, 2003-0235659, and 2003-0001108, each of which is incorporated herein by reference in its entirety. Suitable electron beam emitting devices are available, for example, from Energy Sciences, Inc.

The amount of radiation necessary to cure the composition will of course depend on the angle of exposure to the radiation, the thickness of the coating of the radiation-curable composition layer, and the concentration and reactivity of the functional groups present in the reactive components of the composition. Typically, an ultra-violet source with a wavelength between 200 and 300 nm (e.g. a filtered mercury arc lamp) or an electron beam source is directed at a substrate coated with the radiation-curable composition carried on a conveyor system which provides a rate of passage past the radiation source appropriate for the radiation absorption profile of the composition (which profile is influenced by the degree of cure desired, the thickness of the coating to be cured, and the rate of polymerization of the composition). For example, the particle beam processing device may be operated at a voltage of 125 kVolts or less (e.g. about 60 to about 110 kVolts, although voltages higher than 125 kVolts may also be utilized), with the highly accelerated electrons emitting energy within the range of from about 0.5 Mrads to about 10 Mrads (e.g., about 1 to 7 Mrads).

The coated, thin, flexible substrates of the present invention are especially suitable for the fabrication of packages, such as retortable pouches for the packaging of food, as the coating formed by curing the radiation-curable composition provides excellent protection of images printed on the substrate surface. Illustrative examples of such packages include VFFS packages, HFFS packages, lidded trays or cups which use the coated substrate as the lidding material, end-seal bags, side-seal bags, L-seal bags, and pouches which are sealed on three sides but open at the top. For example, a pillow pouch may be formed from two sheets of the substrate having a sealable layer on the side opposite the side bearing the cured coating that are arranged so that the sides having the sealable layer thereon are positioned facing each other and then joined and sealed together around their respective edges (by heat sealing or by use of an adhesive, for example). The heat sealing can be performed by any one or more of a wide variety of methods, such as the use of heated bars, hot wires, hot air, infrared radiation, ultrasonic radiation, radio or high frequency radiation, heating knives, impulse sealers, ultrasonic sealers, induction heating sealers, etc., as appropriate. Alternatively, one of the two sheets may be an uncoated thin, flexible substrate (which may be the same as or different from the substrate coated with the cured radiation-curable composition) provided it has the capability of being similarly sealed to the other sheet. A storage space is thereby defined by the non-sealed area between the two sheets and within the sealed edges. The storage space contains the contents of the pouch (e.g., a foodstuff) and is ultimately sealed off from the surrounding environment. The sealed package may thereafter be subjected to a retort treatment, e.g., heating to a temperature of at least about 120 degrees for a time effective to pasteurize the contents of the pouch (e.g., about 20 to about 90 minutes). The coated, thin, flexible substrate can be formed in any suitable shape that may be desired for containing the foodstuff, such as, for example, a rectangular or square or other polygonal or non-polygonal shape.

A single sheet of the coated thin, flexible substrate in accordance with the invention could alternatively be used. This sheet can be folded upon itself (with a sealable layer on the inside) to form the two sides of the pouch. Once the desired product (e.g., a foodstuff) is placed within the folded-over sides, the remaining edges of the sheet may be sealed together so as to enclose the contents.

The present invention thus provides a method of packaging a foodstuff, said method comprising
a) forming a thin, flexible substrate (which may contain one or more layers);
b) applying a printed image on at least one side of the thin, flexible substrate to form a printed substrate;
c) coating at least the printed image with a radiation-curable composition comprising at least one radiation-curable monomer or oligomer containing one or more (meth)acrylate groups per molecule and one or more functional groups per molecule selected from the group consisting of hydroxyl groups and carboxylic acid groups;
d) curing the radiation-curable composition using ultraviolet and/or electron beam radiation to form a coated, printed substrate;
e) forming a package comprising at least the coated, printed substrate;
f) placing a foodstuff within the package;
g) sealing the package to enclose the foodstuff and to provide a packaged foodstuff; and
h) subjecting the packaged foodstuff to retort conditions.

The present invention also provides a method of packaging a foodstuff, said method comprising:
a) forming a sheet comprising a coated, thin, flexible substrate into a pouch including a storage space formed by said at least one sheet, either alone or in cooperation with at least one additional sheet, wherein at least one surface has a coating obtained by exposing a composition comprising at least one radiation-curable monomer or oligomer containing one or more (meth)acrylate groups per molecule and one or more functional groups per molecule selected from the group consisting of hydroxyl groups and carboxylic acid groups to an amount of ultraviolet and/or electron beam radiation sufficient to react said radiation-curable monomer or oligomer;
b) placing said foodstuff into said storage space;
c) sealing said pouch; and
d) heating the sealed pouch at a temperature of at least 120 degrees for at least 30 minutes.

In one embodiment, the coated, thin, flexible substrate has a sealable inner layer (preferably, a heat sealable layer) that is sealed to itself or to a second sealable layer when the pouch is being formed. Also, it is preferred that the pouch be completely sealed so as to substantially inhibit the ingress of bacteria into the storage space. Preferably, the materials used in the pouch and the sealing method are selected such that the sealed pouch containing the foodstuff is capable of withstanding retorting (e.g., heating at a temperature of at least 100, at least 110, or at least 120 degrees C. for at least 30 minutes without delamination or degradation of the pouch or breakage or release of the seal). A coated, thin, flexible substrate according to the present invention may also be utilized to manufacture a gusset or stand-up retortable pouch. For example, a gusset pouch may include two sheets of the coated, thin, flexible substrate (or, alternatively, one sheet of the coated, thin, flexible substrate and a sheet of a different thin, flexible substrate having one side that is capable of being sealed to the coated, thin, flexible substrate). One sheet is folded to form the front and back sheets of the pouch. The sheets are joined and sealed together about their respective edges (by heat sealing, for example) around the sides and top, with seals also formed in the bottom gusset. The area between the three sheets and within the heat seals thereby creates a storage space that is sealed off from the surrounding environment and contains the contents of the pouch such as a foodstuff. The sheets can be any shape suitable or desired for containing a foodstuff, including for example a rectangular or square or other polygonal or non-polygonal shape.

In one embodiment, a pouch machine is fed with two webs of the coated, thin, flexible substrate (or, alternatively, one web of a coated, thin, flexible in accordance with the present invention and one web of a different thin, flexible substrate). A main web is used as the source of a sheet that is folded in half along one side of the pouch to form a front sheet and the back sheet, which are positioned in alignment with and on top of each other. The free edges of the sheets are sealed together along the other side of the pouch. The second web is fed into the side of the machine to form a bottom gusset sheet, which is sealed to the front and back sheets to form an open-topped pouch. After the pouch has been filled with a foodstuff or the like, the top edges of the front and back sheets are sealed together using a suitable sealing method. It will also be apparent that a single sheet of the thin flexible substrate of the present invention could be utilized to form a gusset or stand-up retortable pouch. For example, the sheet could be folded upon itself to form the three sheets mentioned previously. Typically, the middle of the single sheet would form the desired gusset, and the ends would meet at the top of the pouch. The unconnected side and top edges may then be sealed, at least one of them being sealed only after the foodstuff or other material to be packaged is placed between the folded-over sheet.

The coated, thin, flexible substrates provided by the present invention may also be used in the manufacture of semirigid or rigid packaging containers (including retortable containers). Such a container may comprise, for example:

a) a container tray having a flange for sealing; and

b) a sheet of a coated, thin, flexible substrate in accordance with the invention;

wherein the coated, thin, flexible substrate has a sealable layer on one side which is sealed to the flange of the container tray (using heat sealing or adhesive sealing, for example).

The coated, thin, flexible substrates of the invention thus can be used as lidding stock in a process for preparing a food package comprising the steps of:

a) filling a flanged plastic tray with a food product;

b) positioning a sheet of the coated, thin, flexible substrate over the filled tray (with the sealable layer facing the flange of the plastic tray); and

c) sealing the sheet of the coated, thin, flexible substrate entirely around the flange of the tray so as to enclose the food package and so as to leave a loose edge or tab of the sheet for opening the food package. When the loose edge or tab is peeled back, the seal between the coated, thin, flexible substrate and the tray cohesively fails.

The sealable layer may be a heat sealable layer and may be comprised of two different films (for example, two different polyolefin films) so that when the above described food package is opened, the interface between the two different films in the sealable layer cohesively fails. One layer remains on the flange of the tray while the other layer is peeled off along with the remainder of the coated, thin, flexible substrate. The sealable layer may, for example, be a co-extruded film. Of course, where the container is intended to be retorted, this type of arrangement must also be capable of surviving retort conditions and other processing of the food package such that the seal between the two layers remains intact during such processing, thereby avoiding any release or contamination of the contents of the food package prior to the time the user wishes to open the food package.

Other approaches known in the art may also be employed to incorporate the coated, thin, flexible substrates of the present invention into pouches, containers, enclosures and the like. That is, a web of the coated, thin, flexible substrate may be substituted for a web of any conventional flexible laminate, including laminates having a sealable layer on at least one side.

As an example, in most cold seal packaging applications, a cold seal adhesive is applied in a pattern around the perimeter of a sheet of a film laminate. The film laminate sheet is then positioned adjacent to a second sheet of a film laminate also bearing a layer of cold seal adhesive around its perimeter, with the layers of cold seal adhesive being pressed against each other at about room temperature to bond the two sheets together. The coated, thin, flexible substrate of the present invention may be substituted for one or both of the above-mentioned film laminate sheets, with the cold seal adhesive being applied to the sealable layer side of the coated, thin, flexible substrate sheet.

The coated, thin, flexible substrates described herein may also be used in packaging applications where the package contains a substance or object other than a foodstuff and/or where the package is not subjected to retorting.

For instance, the coated, thin, flexible substrates of the present invention may be readily adapted for use in form-fill-seal (FFS) packaging, aseptic packaging, cold seal packaging, resealable/reclosable containers and the like. Products other than foodstuffs that are capable of being packaged or encapsulated using pouches, bags, containers or other enclosures formed from the coated, thin, flexible substrates include, but are not limited to, personal care products (e.g., soap, cosmetics, lotions, shampoos, conditioners, styling gels), electronic/electrical components (e.g., batteries), cleaning products (e.g., hard surface cleaners, wipes), medical products (e.g., drugs, antiseptic products), maintenance products (e.g., oil, lubricant, polishes) and the like.

### Examples

A number of different radiation-curable coating compositions in accordance with the present invention were prepared by combining the various components described in Table 1 (the amount of each component is expressed in weight percent based on the total weight of the composition).

TABLE 1

| | | Example | Example | Example | Example | Example | Example |
|---|---|---|---|---|---|---|---|
| Component | Description | 1 | 1A | 2 | 3 | 4 | 4A |
| CN 3100¹ | Acrylate oligomer w/OH functionality | 10 | 10 | — | — | — | — |
| PHOTOMER 5429² | Tetrafunctional oligomer (polyester acrylate) | 10 | — | — | — | — | — |
| TYCEL 7910³ | NCO-terminated polyurethane prepolymer | 11 | 11 | — | — | — | — |
| ECX 4046⁴ | Carboxylic acid functionalized monoacrylate | 50 | 50 | — | — | — | — |
| JR4-199⁵ | UV curable acrylic resin | 8 | 8 | — | — | — | — |
| SR 256⁶ | 2-(2-Ethoxyethoxy)ethyl acrylate | 5 | 5 | — | — | — | — |
| SARCURE SR 1129⁷ | Photoinitiator | 4 | 4 | 4 | 4 | — | — |
| DAROCUR 1173⁸ | 2-hydroxy-2-methyl-phenyl-propan-1-one | 2 | 2 | 2 | 2 | — | — |
| CN 3002⁹ | Acrylic monomer + tackifier | — | 10 | — | — | — | — |
| LR 8765¹⁰ | Aliphatic epoxy acrylate | — | — | 30.4 | 31 | 32.93 | 32.29 |
| CD 580¹¹ | Alkoxylated cyclohexane dimethanol diacrylate | — | — | 9.9 | 6 | 6.38 | 10.53 |
| PHOTOMER 4361¹² | 1,6-hexanediol (2) ethoxylate diacrylate | — | — | 20 | 23 | 24.47 | 21.28 |
| PHOTOMER 4703¹³ | Carboxyl-functional acrylic monomer | — | — | 12.8 | — | — | 13.63 |
| PHOTOMER 4149¹⁴ | Trimethylolpropane 3 EO triacrylate | — | — | 13.9 | 11 | 11.7 | 14.79 |
| PHOTOMER 8127¹⁵ | Monomethoxy neopentyl glycol propoxylate | — | — | 6 | 7 | 7.45 | 6.38 |
| | monoacrylate (2 PO) | | | | | | |
| LA 1118-68¹⁶ | Epoxy acrylate | — | — | — | 10 | 10.64 | — |
| CN 990¹⁷ | Siliconized urethane acrylate | — | — | — | 6 | 6.38 | — |
| 4-Methoxyphenol | | — | — | — | — | 0.05 | 0.05 |
| (MEHQ) | | | | | | | |
| Lambent SA-CM¹⁸ | Tetrafunctional vinyl silicone | — | — | 1 | — | — | 1.06 |

¹Sartomer (according to the supplier's MSDS, this product contains “low viscosity acrylic oligomer” (amount proprietary), “methacrylate acid ester” (amount proprietary), “acrylic ester” (up to 4 weight %), and “aliphatic urethane acrylate” (amount proprietary)
²Cognis Corporation
³Henkel Corporation (Liofol)
⁴Cognis Corporation
⁵Estron (solid acrylic polymer diluted in [2-(2-ethoxyethoxy)ethyl acrylate])
⁶Sartomer
⁷Sartomer
⁸Ciba
⁹Sartomer
¹⁰BASF
¹¹Sartomer
¹²Cognis Corporation
¹³Cognis Corporation
¹⁴Cognis Corporation
¹⁵Cognis Corporation
¹⁶Henkel Corporation (Liofol)
¹⁷Sartomer (described by supplier as “aliphatic urethane acrylate containing bound silicone”)
¹⁸Lambent Technologies

The compositions of Examples 1 and 1A were each applied to the printed side of a polyethylene terephthalate (PET) film substrate and then cured by exposure to UV light using a 300 w/in medium pressure mercury arc lamp (H bulb at 100% power and 200 ft/min conveyor speed). After curing the compositions, the coated substrates were tested (adhesion of coating/tape test; MEK rubs; gloss at 60 degrees). The cured, coated substrates were then retorted at 121 degrees C. and 15 psi pressure for 30 minutes and then retested. Neither cured, coated substrate exhibited delamination or water spots after being subjected to retort conditions. The following results were observed (Table 2):

TABLE 2

| Test | Example 1 | Example 1A |
|---|---|---|
| Adhesion (before retort) | Pass | Pass |
| Adhesion (after retort) | Pass | Pass |
| Gloss (before retort) | 90.9 | 90.7 |
| Gloss (after retort) | 65.2 | 80 |
| MEK Rubs (before retort) | 50 | 44 |
| MEK Rubs (after retort) | 7 | 15 |

Cured, coated substrates were prepared and tested as described above, except that the curable compositions used corresponded to Examples 2 and 3 in Table 1. The curable compositions before curing had viscosities of 132 cps and 200 cps, respectively, at 25 degrees C. The cured, coated substrates had no odor (before or after being retorted) and exhibited no delamination or water spots after being subjected to retort conditions. The following additional results were observed (Table 3):

TABLE 3

| Test | Example 2 | Example 3 |
|---|---|---|
| Adhesion (before retort) | Pass | Pass |
| Adhesion (after retort) | Pass | Pass |
| Gloss (before retort) | 88.7 | 91.4 |
| Gloss (after retort) | 86.7 | 88 |
| MEK Rubs (before retort) | 50 | 50 |
| MEK Rubs (after retort) | 50 | 25 |

The cured coatings obtained by irradiation of the compositions of Examples 2 and 3 thus exhibited significantly improved resistance to retort conditions (as reflected in gloss retention and MEK rub resistance) as compared to the cured coatings derived from the compositions of Examples 1 and 1A.

The compositions of Examples 4 (viscosity=188 cps at 25 degrees C.) and 4A (viscosity=128 cps at 25 degrees C.) were each applied to the printed side of a polyethylene terephthalate (PET) film substrate and then cured by exposure to electron beam (EB) radiation. After curing the compositions, the coated substrates were tested (adhesion of coating/tape test; MEK rubs; gloss at 60 degrees). The cured, coated substrates were then retorted at 121 degrees C. and 15 psi pressure for 30 minutes and then retested. Neither cured, coated substrate exhibited delamination or water spots after being subjected to retort conditions. No odor was detected before or after retorting. The following additional results were observed (Table 4):

TABLE 4

| Test | Example 4 | Example 4A |
|---|---|---|
| Adhesion (before retort) | Pass | Pass |
| Adhesion (after retort) | Pass | Pass |
| Gloss (before retort) | 88.7 | 88.9 |
| Gloss (after retort) | 81 | 80.1 |
| MEK Rubs (before retort) | 50 | 50 |
| MEK Rubs (after retort) | 50 | 50 |

The compositions of Examples 1 and 1A were applied to the foil side of a foil/CPP laminate and then cured by exposure to UV light using a 300 w/in medium pressure mercury lamp (H bulb at 100% power, 100 ft/min conveyor speed). Pouches were fabricated from the cured, coated substrates and then filled with MIGLYOL 812 (triglyceride derived from coconut oil; product of Dynamit Nobel). The filled pouches were subsequently retorted (240 degrees F., 15 psi, 1 hour). Before being retorted, both cured, coated substrates passed an adhesion (tape) test and had no odor (Example 1 yielded a coating exhibiting an MEK rubs rating of 5; Example 1A yielded a coating exhibiting an MEK rubs rating of 4). After being retorted, both cured, coated substrates passed an adhesion (tape) test, had no odor, and did not exhibit any tunneling, delamination, or water spots. The retorted pouches did not exhibit any flaking or leakage of their contents.

1. A retortable package comprised of at least one thin, flexible substrate selected from the group consisting of plastic films and metallic foils, wherein said thin, flexible substrate forms an outer surface of said retortable package and wherein said outer surface has a cured coating thereupon formed by exposing a composition comprising at least one radiation-curable monomer or oligomer containing one or more (meth)acrylate groups per molecule and one or more functional groups per molecule selected from the group consisting of hydroxyl groups and carboxylic acid groups to at least one of electron beam radiation or ultraviolet radiation.

2. The retortable package of claim 1, wherein said composition is additionally comprised of at least one alkoxylated cyclohexane dimethanol di(meth)acrylate.

3. The retortable package of claim 1, wherein said composition is additionally comprised of at least one photoinitiator.

4. The retortable package of claim 1, wherein said composition is comprised of a first radiation-curable monomer or oligomer containing one or more (meth)acrylate groups per molecule and at least one hydroxyl group per molecule and a second radiation-curable monomer or oligomer containing one or more (meth)acrylate groups per molecule and at least one carboxylic acid group per molecule.

5. The retortable package of claim 1, wherein said composition is comprised of at least one (meth)acrylate oligomer having hydroxyl functionality.

6. The retortable package of claim 1, wherein said composition is comprised of at least one carboxylic acid-functionalized mono(meth)acrylate.

7. The retortable package of claim 1, wherein said composition is comprised of at least 30 weight percent carboxylic acid-functionalized mono(meth)acrylate.

8. The retortable package of claim 1, wherein said composition is additionally comprised of at least one (meth)acrylate-functionalized monomer or oligomer that does not contain either hydroxyl or carboxylic acid functional groups.

9. The retortable package of claim 1, wherein said composition is essentially free of non-reactive solvents.

10. The retortable package of claim 1, wherein said composition is comprised of at least one (meth)acrylate oligomer having hydroxyl functionality, at least one carboxylic acid-functionalized mono(meth)acrylate, and at least one (meth)acrylate-functionalized monomer or oligomer that does not contain either hydroxyl or carboxylic acid functional groups.

11. The retortable package of claim 1, wherein said composition is comprised of at least one epoxy (meth)acrylate.

12. The retortable package of claim 1, wherein said composition is comprised of at least 20 weight % epoxy (meth)acrylate.

13. The retortable package of claim 1, wherein said composition is additionally comprised of at least one alkoxylated alcohol (meth)acrylate containing at least one (meth)acrylate functional group per molecule.

14. The retortable package of claim 1, wherein said composition is additionally comprised of at least one alkoxylated alcohol (meth)acrylate containing at least two (meth)acrylate functional groups per molecule.

15. The retortable package of claim 1, wherein said composition is additionally comprised of at least one reactive silicon-containing slip agent.

16. The retortable package of claim 1, wherein said composition is additionally comprised of at least one alkoxylated alcohol mono(meth)acrylate, at least one alkoxylated alcohol di(meth)acrylate, and at least one alkoxylated alcohol tri(meth)acrylate.

17. The retortable package of claim 1, wherein said composition is comprised of a) about 25 to about 50 weight percent of at least one epoxy (meth)acrylate, b) about 0.5 to about 10 weight percent of one or more reactive silicon-containing slip agents, c) about 25 to about 35 weight percent of one or more alkoxylated alcohol mono(meth)acrylates, d) about 3 to about 10 weight percent of one or more alkoxylated alcohol di(meth)acrylates, and e). about 6 to about 20 weight percent of one or more alkoxylated alcohol tri(meth)acrylates.

18. A packaged food product comprising:
a). a food product; and
b). a package enclosing the food product, the package comprising a coated, printed sheet which is thin and flexible and which comprises:
i). a substrate film comprising one or more thermoplastic polymers, the substrate film having a print side on the outside of said package;
ii). an image printed on the print side of the substrate film; and
iii). a cured coating over the image which is formed by applying a layer of a composition comprising at least one radiation-curable monomer or oligomer containing one or more (meth)acrylate groups per molecule and one or more functional groups per molecule selected from the group consisting of hydroxyl groups and carboxylic acid groups and exposing said composition to at least one of electron beam radiation and ultraviolet radiation.

19. A method of preparing a packaged food product, said method comprising:
a). placing a food product in a package;
b). sealing said package so as to enclose said food product in said package to produce a sealed package; and
c). subjecting said sealed package enclosing said food to retort conditions;
wherein package comprises a coated, printed sheet which is thin and flexible and which is comprised of:
i). a substrate film comprising one or more thermoplastic polymers, the substrate film having a print side on the outside of said package;
ii). an image printed on the print side of the substrate film; and
iii). a cured coating over the image which is formed by applying a layer of a composition comprising at least one radiation-curable monomer or oligomer containing one or more (meth)acrylate groups per molecule and one or more functional groups per molecule selected from the group consisting of hydroxyl groups and carboxylic acid groups and exposing said composition to at least one of electron beam radiation and ultraviolet radiation.

20-22. (canceled)
